(19) United States
(12) Patent Application Publication
(10) Pub. No.: US 2007/0226893 A1
(43) Pub. Date: Oct. 4, 2007

(54) Flange fitting for bathtubs and spas

(75) Inventor: Mark R. Edris, Glendora, CA (US)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: ITT Industries

(21) Appl. No.: 11/396,395

(22) Filed: Mar. 30, 2006

(51) Int. Cl. A61H 33/04

(52) U.S. Cl. 4/541.6

(57) ABSTRACT

A fitting arrangement is provided for coupling to a tub or spa wall featuring a wall fitting for inserting through a mounting opening in the tub or spa wall and having one or more corresponding rotational locking members; and a jet body having one or more rotational locking members for snapping onto one or more corresponding rotational locking members of the wall fitting as the jet body is advanced into the wall fitting to prevent the jet body and wall fitting from separating from one another.

### BACKGROUND OF THE INVENTION

1. Field of Invention

The present invention relates to a bath tub or spa, and more particularly relates to a fitting arrangement for coupling to such a tub or spa wall.

2. Description Of Related Art

In the prior art, many plastic fittings used in plumbing applications for bathtubs and spas require a sandwich method of attaching them to the bathtub or spa wall. A flange is generally used on the inside of the wall (water side) and a threaded nut is used on the outside of the wall (non-water side). The plastic fitting is then secured to the wall by tightening the threaded nut, the flange or both. However, there are situations that occur in which it is not possible to mold the flange on the plastic fitting and it would be desirable to attach a flange for purposes of securing the plastic fitting to the wall.

### SUMMARY OF THE INVENTION

The present invention provides a method and apparatus for coupling a new and unique fitting arrangement to a tub or spa wall. The method features steps of inserting a wall fitting having one or more rotational locking members through a mounting opening in the tub or spa wall and snapping one or more corresponding rotational locking members on a jet body onto the one or more rotational locking members on the wall fitting as the jet body is advanced into the wall fitting to prevent the jet body and wall fitting from separating from one another.

The apparatus takes the form of the fitting arrangement itself, which features in combination the wall fitting having the one or more rotational locking members for inserting through the mounting opening in the tub or spa wall in combination with the jet body having the one or more corresponding rotational locking members for snapping onto the one or more rotational locking members of the wall fitting as the jet body is advanced into the wall fitting to prevent the jet body and wall fitting from separating from one another.

According to the present invention, the one or more corresponding rotational locking members on the jet body may include one or more locking tabs that may be arranged on an outer circumferential surface of the jet body; while the one or more rotational locking members on the wall fitting may include one or more indent tabs that may be arranged on an inner circumferential surface of the wall fitting.

Moreover, according to the present invention, the step of snapping may include coupling one or more advancing tabs on the jet body and one or more corresponding advancing tabs on the wall fitting together with rotating the jet body in relation to the wall fitting in order to advance the jet body into the wall fitting. The one or more advancing tabs may include an angled surface slanted in relation to the cylindrical axis of the jet body that are arranged on an outer circumferential surface of the jet body. The one or more corresponding advancing tabs may include a corresponding angled surface slanted in relation to the cylindrical axis of the wall fitting that are arranged on an inner circumferential surface of the wall fitting. During assembly, the rotational cooperation between these corresponding slanted surfaces on the jet body and wall fitting works to draw or advance the jet body into the wall fitting.

In accordance with the present invention, the steps of the method may also include threading a nut onto the wall fitting to hold the wall fitting in place and/or arranging an O-ring between the tub or spa wall and the wall fitting to provide a water tight seal, as well as arranging an O-ring between the tub or spa wall and the jet body to provide a water tight seal.

In order to assemble the fitting arrangement, the O-ring would preferably be inserted into an O-ring groove in the wall fitting, this assembly would be inserted through the mounting opening or hole from inside the tub wall where a nut would be threaded onto the wall fitting to compress O-ring against inside tub wall and hold the wall fitting in place (one of the indent tabs on the wall fitting would typically be pointing in the 12 o'clock position in order for the jet body to mount vertically). While the wall fitting is held in place the jet body with another O-ring is inserted into the wall fitting and rotated in the clockwise direction in order to advance the jet body into the wall fitting. During insertion of the jet body, the locking tabs on the jet body snap into the indent tabs on the wall fitting, which locks the jet body onto the wall fitting which prevents the assembled unit from separating.

The present invention may be applied on any type of jet, dry jet or the like, and may be set up on either a bathtub, tub, spa, etc.

One important advantage of this embodiment of the present invention is that the harness assembly can be pre-assembled and coupled to the jet body before the jet body is coupled to the wall fitting, which makes for quicker and easier assembly of the fitting arrangement to the tub or spa wall.

In an alternative embodiment according to the present invention, the fitting arrangement may be assembled as follows: The O-ring is placed onto the jet body, the nut is then threaded onto this assembly, and this assembly is then inserted from the outside wall of the tub through the chosen mounting location. From inside the tub wall, the wall fitting and another O-ring would be slid onto the jet body and twisted in a clockwise direction so that the wall fitting advances into the jet body (the other O-ring is put into O-ring groove in wall fitting). Once the above steps are performed, from the outside tub wall the jet body is held so that the water socket points in the vertical direction, and the nut is then tightened from the outside to seal the wall fitting and compress the other O-ring against the inside tub wall and to hold the unite in place.

Furthermore, in still another alternative embodiment according to the present invention, an O-ring may be arranged between an angled surface of the wall fitting and a circumferential channel of the jet body for providing an additional improved water tight seal.

The embodiments of the present invention provide a new and unique design of a flange or wall fitting that can be attached to a plumbing fitting that will provide a strong mechanical connection as well as a leak tight seal.

### BRIEF DESCRIPTION OF THE DRAWING

The drawing includes the following Figures, which are not necessarily drawn to scale:

FIG. 1 includes FIG. 1a which is an assembled view of a fitting arrangement according to the present invention, and also includes FIG. 1b which is an exploded view of the fitting arrangement shown in FIG. 1a. Moreover, FIG. 1C is a front view of a large dry jet—manifold assembly; and FIG. 1C is a front view of the large dry jet—manifold assembly shown in FIG. 1C.

FIG. 2 includes FIG. 2a which is a front perspective view of the wall fitting shown in FIG. 1b according to the present invention; FIG. 2b which is a back perspective view of the wall fitting shown in FIG. 2a; FIG. 2c which is a side view of the wall fitting shown in FIG. 2a; and FIG. 2d which is an enlarged perspective view similar to the wall fitting shown in FIG. 2a.

FIG. 3 is a perspective view of a jet body shown in FIG. 1b according to the present invention.

FIGS. 4a, 4b, 4c are cross-sectional assembled views of three embodiments of the present invention, each having different water/air connections.

FIG. 5 is an exploded view of the dry jet 300 shown in FIG. 4c.

FIGS. 6a and 6b are front and rear views of the flange assembly and flange assembly O-ring shown in FIG. 5.

FIGS. 7a, 7b, 7c, 7d and 7e show the manifold/barb configuration of the dry jet shown in FIG. 4a; including FIGS. 7b, 7c and 7d which are cross-sectional views along sections lines A-A, B-B and C-C respectively in FIG. 7a; and including FIG. 7e which is a projected view of the dry jet shown in FIG. 7a.

FIGS. 8a, 8b, 8c and 8d show the socket/barb configuration of the dry jet shown in FIG. 4b, including FIG. 8b which is a cross-sectional view along sections line A-A shown in FIG. 8a, including FIG. 8c which is a projected view of the dry jet shown in FIG. 8a rotated 90 degrees, and including FIG. 8d which is a projected view of the dry jet shown in FIG. 8a.

FIGS. 9a, 9b, 9c and 9d show the socket/socket configuration of the dry jet shown in FIG. 4c, including FIG. 9b which is a cross-sectional view along sections line A-A shown in FIG. 9a, including FIG. 9c which is a projected view of the dry jet shown in FIG. 9a rotated 90 degrees, and including FIG. 9d which is a projected view of the dry jet shown in FIG. 9a.

FIG. 10a, 10b show cross-sectional views of an alternative embodiment of the present invention.

### DETAILED DESCRIPTION OF THE INVENTION

### The Basic Invention

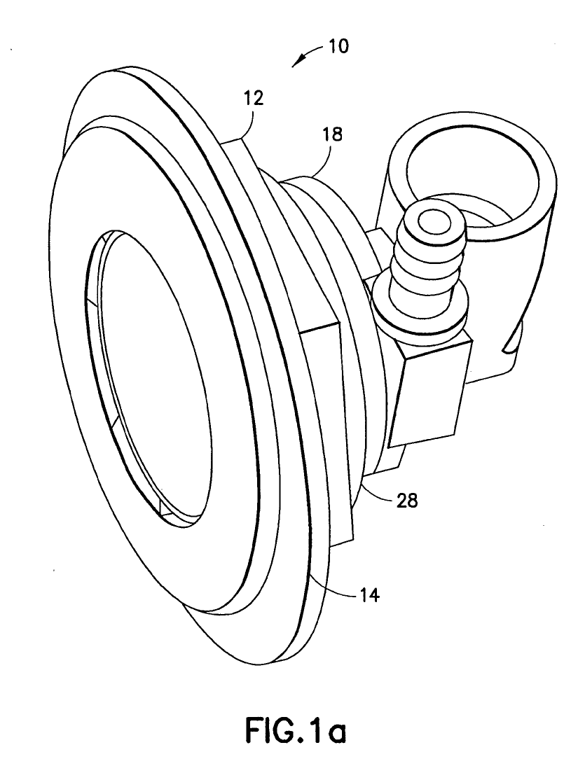

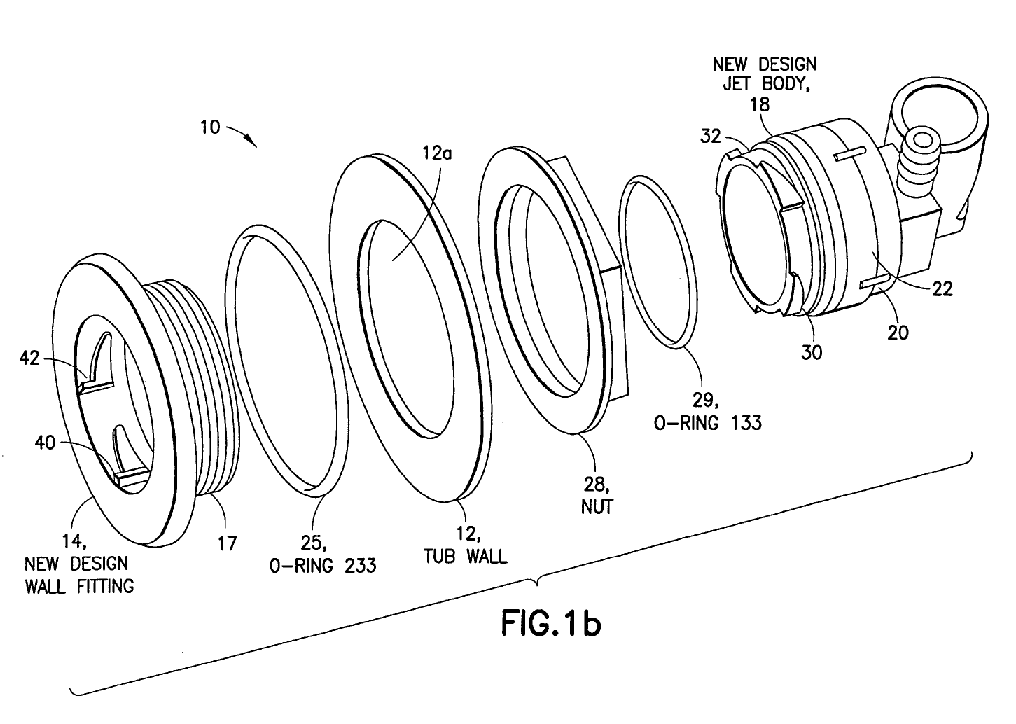

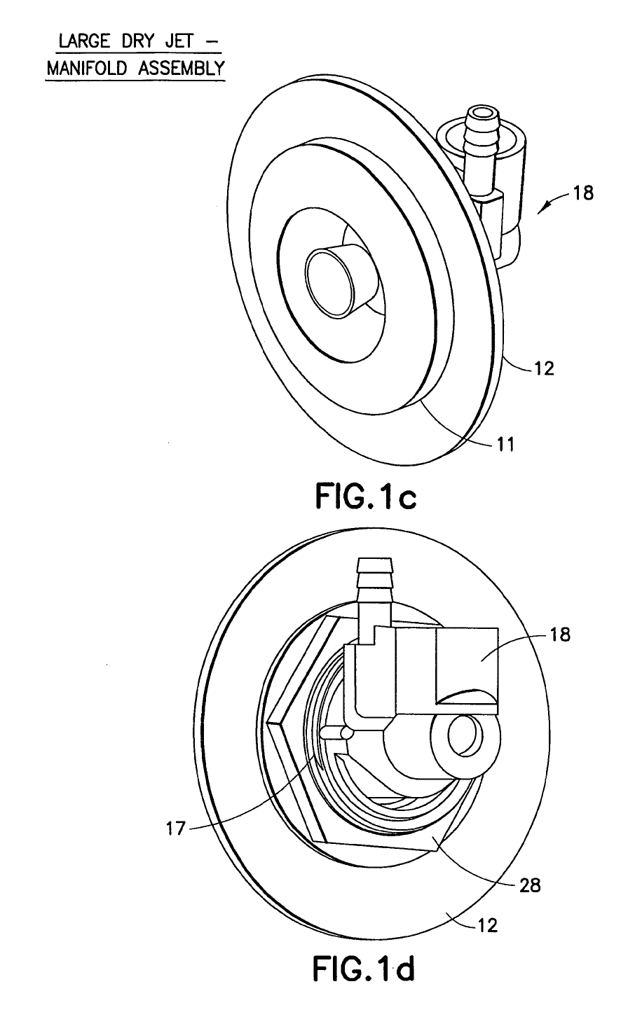

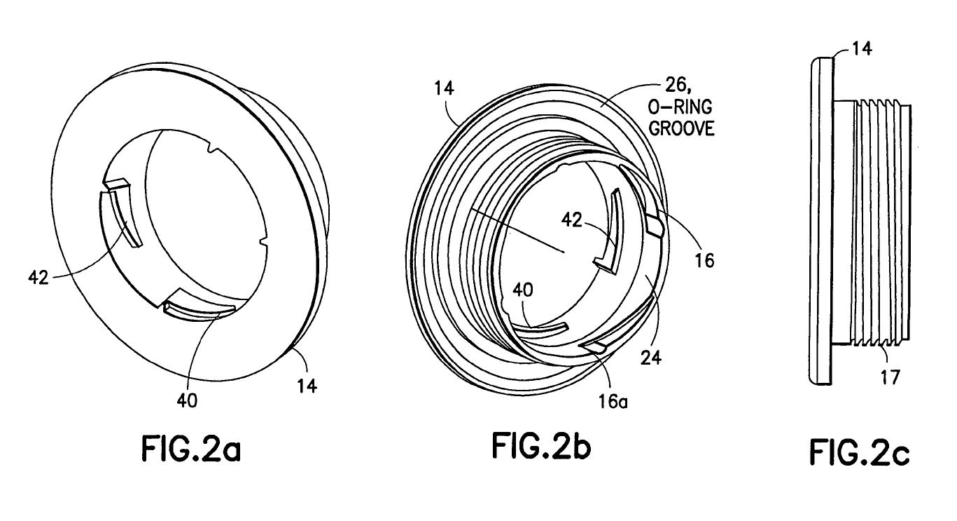

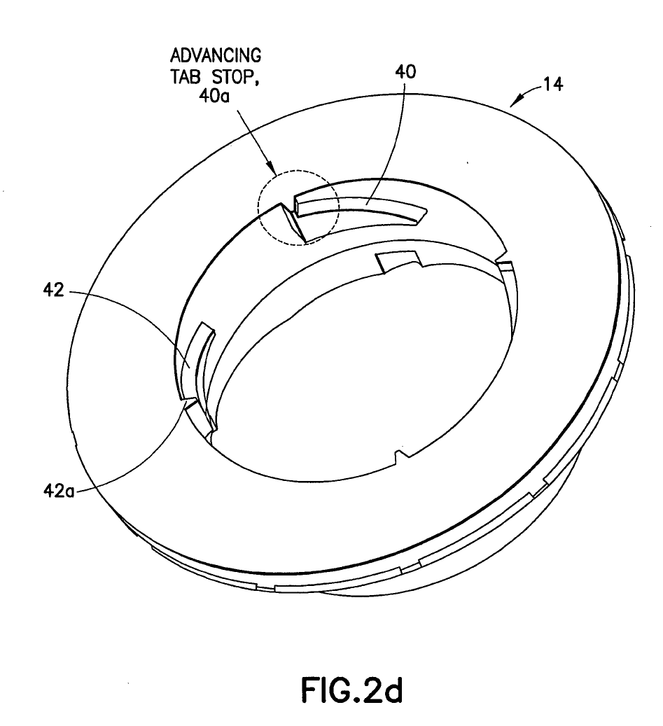

FIGS. 1-3 show one embodiment of a fitting arrangement generally indicated as 10 for coupling to a tub or spa wall 12. The fitting arrangement 10 features a wall fitting 14 (see FIG. 2) for inserting through a mounting opening 12a in the tub or spa wall 12 and having one or more rotational locking members 16 as shown in FIG. 2b; and a jet body 18 (see FIG. 3) having one or more corresponding rotational locking members 20 for snapping onto the one or more rotational locking members 16 of the wall fitting 14 as the jet body 18 is advanced into the wall fitting 14 to prevent the jet body 18 and wall fitting 14 from separating from one another. The fitting arrangement 10 also includes a rotary assembly 11 (FIG. 1C) as shown.

### The Rotational Locking Members 16, 20

As best shown in FIG. 2b, the one or more rotational locking members 16 on the wall fitting 14 include one or more indent tabs that are arranged on an inner circumferential surface 24 of the wall fitting 14. By way of example, the one or more indent tabs 16 take the form of four gradually curved recesses in the inner circumferential surface 14 of the wall fitting 14. Each gradually curved recess has a respective bump 16a (FIG. 2b). The four gradually curved recesses 16 are circumferentially arranged equi-distantly about the inner circumferential surface 24 of the wall fitting 14. The scope of the invention is not intended to be limited to the type, kind, shape, placement, arrangement, etc. of the one or more indent tabs 16, and embodiment are envisioned using the other types, kinds, shapes, placements, arrangements, etc. of one or more indent tabs 16 either now known or later developed in the future within the spirit of the present invention.

As best shown in FIG. 3, the one or more corresponding rotational locking members 20 on the jet body 18 include one or more locking tabs 20 that are arranged on an outer circumferential surface 22 of the jet body 18. By way of example, the one or more locking tabs 20 take the form of four semi-cylindrical protuberances raised from the outer circumferential surface 22 of the jet body 18. The four semi-cylindrical protuberances 20 are circumferentially arranged equi-distantly about the outer circumferential surface 22 of the jet body 18. The placement or arrangement of the four semi-cylindrical protuberances 20 on the outer circumferential surface 22 of the jet body 18 corresponds to the placement or arrangement of the four gradually curved recesses 16 on the inner circumferential surface 24 of the wall fitting 14. In operation, each semi-cylindrical protuberance 20 catches and frictionally engages with a corresponding bump 16a of the wall fitting 14 when the jet body 18 is advanced into the wall fitting 14 to prevent the jet body 18 and wall fitting 14 from separating from one another. The scope of the invention is not intended to be limited to the type, kind, shape, placement, arrangement, etc. of the one or more locking tabs 20, and embodiment are envisioned using the other types, kinds, shapes, placements, arrangements, etc. of one or more locking tabs 20 either now known or later developed in the future within the spirit of the present invention.

### The Advancing Tabs 30, 32, 40, 42

The jet body 18 also includes one or more advancing tabs 30, 32 that rotationally cooperate with one or more corresponding advancing tabs 40, 42 of the wall fitting 14 to advance the jet body 18 into the wall fitting 14, as best shown in FIG. 3. By way of example, the one or more advancing tabs 30, 32 take the form of four angled surfaces slanted in relation to the cylindrical axis of the jet body 18 that are arranged on an outer circumferential surface of the jet body 18. The four angled surfaces 30, 32 are circumferentially arranged equi-distantly about the inner circumferential surface 24 of the wall fitting 14. The scope of the invention is not intended to be limited to the type, kind, shape, slant, placement, arrangement, etc. of the one or more angled surfaces 30, 32, and embodiment are envisioned using the other types, kinds, shapes, slants, placements, arrangements, etc. of one or more angled surfaces 30, 32 either now known or later developed in the future within the spirit of the present invention.

Similarly, the one or more corresponding advancing tabs 40, 42 on the wall fitting 14 are best shown in FIGS. 2a, 2b and 2d and may take the form of four corresponding angled surfaces slanted in relation to the cylindrical axis of the wall fitting 14 that are arranged on an inner circumferential surface 24 of the wall fitting 14. The four corresponding angled surfaces 40, 42 are circumferentially arranged equi-distantly about the inner circumferential surface 24 of the wall fitting 14 and have corresponding advancing tab stops 40a, 42a for stopping the advancement of the tabs 40, 42. The placement or arrangement of the four corresponding angled surfaces 40, 42 on the inner circumferential surface 24 of the wall fitting 14 corresponds to the placement or arrangement of the four angled surfaces 30, 32 on the outer circumferential surface 22 of the jet body 18. In operation, the snapping action is accomplished by coupling the one or more advancing tabs 30, 32 on the jet body 18 and the one or more corresponding advancing tabs 40, 42 on the wall fitting 14 together and rotating the jet body 18 in relation to the wall fitting 14 to advance the jet body 18 into the wall fitting 14 until each semi-cylindrical protuberance 20 of the jet body 18 catches and frictionally engages with each respective bump 16a of the wall fitting 14. The scope of the invention is not intended to be limited to the type, kind, shape, slant, placement, arrangement, etc. of the one or more angled surfaces 30, 32, and embodiment are envisioned using the other types, kinds, shapes, slants, placements, arrangements, etc. of one or more angled surfaces 30, 32 either now known or later developed in the future within the spirit of the present invention.

The present invention is shown and described, by way of example, having four indent tabs 16, four locking tabs 20, four advancing tabs 30, 32 and four corresponding advancing tabs 40, 42 symmetrically and equi-distantly arranged on the jet body 18 and the wall fitting 14. However, the scope of the invention is not intended to be limited to any particular number or arrangement of the indent tabs, locking tabs, advancing tabs and/or corresponding advancing tabs. For example, embodiments are envisioned using a different number (e.g. 2 or 3), different arrangement, a different shape, etc. of these features either now known or later developed in the future. Moreover, embodiments are envisioned in which the locking and advancing tabs are formed together as an integral member, in which the indent and corresponding advancing tabs are formed together as an integral member, etc.

Moreover, it is important to note that some features of the fitting arrangement 10 shown in FIGS. 1-3 are not described in detail herein because they do not form part of the underlying invention, including water/air connections.

### The Assembly of the Fitting Arrangement 10

In order to assemble the fitting arrangement 10, the following steps may be taken: An O-ring 25 (type 233) would be inserted into an o-ring groove 26 (FIG. 2b) in the wall fitting 14 to provide for a water tight seal. This assembly is then inserted through the mounting hole 12a from inside the tub wall 12 where a nut 28 would be threaded onto threads 17 (FIG. 2c) of the wall fitting 14 to compress the O-ring 25 against the inside of the tub wall 12 and hold the wall fitting 14 in place. (In a preferred embodiment, one of the indent tabs 16 on the wall fitting 16 would be pointing in the 12 o'clock position, as shown, which is done in order for the jet body to be mounted vertically). While the wall fitting 14 is held in place by the nut 28, the jet body 18 with an O-ring 29 (Type 133) is inserted into the wall fitting assembly and rotated in the clockwise direction as shown in order to advance the jet body 18 into the wall fitting assembly. During insertion of the jet body 18, the locking tabs 20 on the jet body 18 snap into the indent tabs 16 on the wall fitting 14, which locks the jet body 18 onto the wall fitting 14 and prevents the assembled unit 10 from separating, as best shown in the assembled view of FIG. 1a.

The scope of the invention is not intended to be limited on the direction that the jet body 18 is rotated in relation to the wall fitting 14. For example, if the advancing tabs on both the jet body 18 and wall fitting 14 were mirrored one could rotate the jet body 18 in the counter-clockwise direction in order to insert the jet body 18 into the wall fitting 14. Thus, in the current design the jet body is rotated clockwise but that can change to a counter-clockwise direction. This change may be implemented because if the nut on the wall fitting 14 is improperly torqued (not tightened enough), the friction of snapping the jet body 18 in the clockwise direction into the indent tabs would cause the nut to loosen. This would thereby reduce the amount of squeeze being applied on the wall fitting o-ring, which would have the possible potential of a water leak. Thus, the scope of the invention is intended to include embodiments that work for either jet body rotation direction, which would be possible if both the wall fitting's and jet body's advancing tabs are oriented.

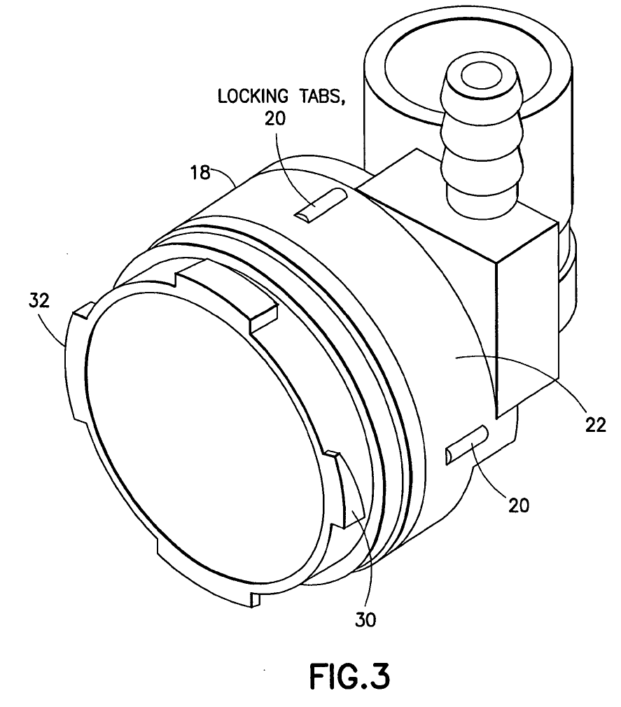

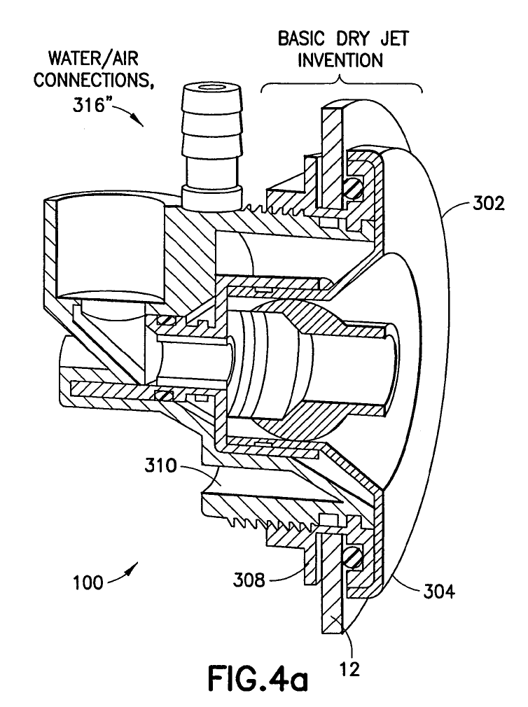

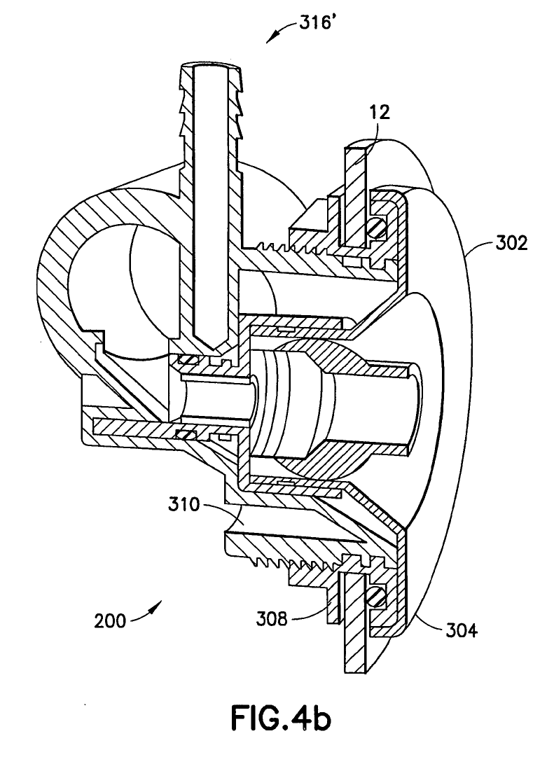

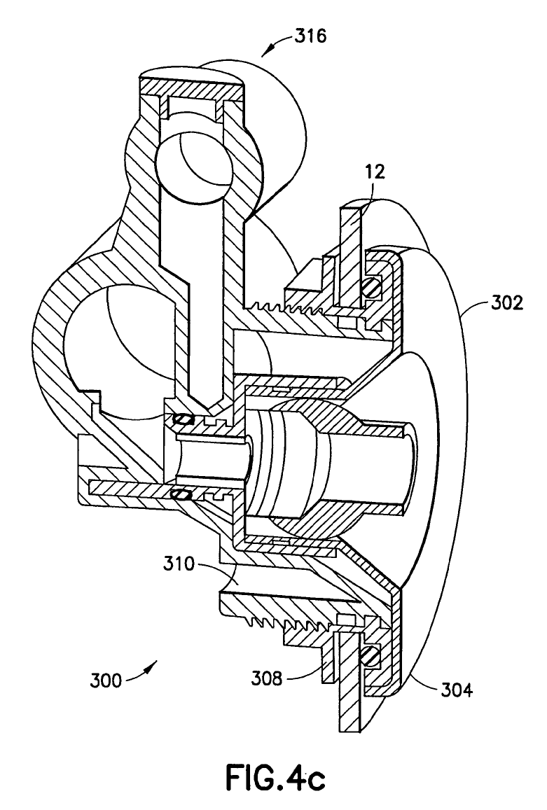

### FIGS. 4-10b

FIGS. 4 through 10b show other embodiments of the present invention, which all feature retainment tabs of a flange assembly that rotationally cooperate with corresponding retainment tabs of a dry jet body to hold or secure an O-ring between the flange assembly to the jet body and another O-ring between the flange assembly and the tub or spa wall when a threaded nut is tightened on the dry jet body, consistent with that described below.

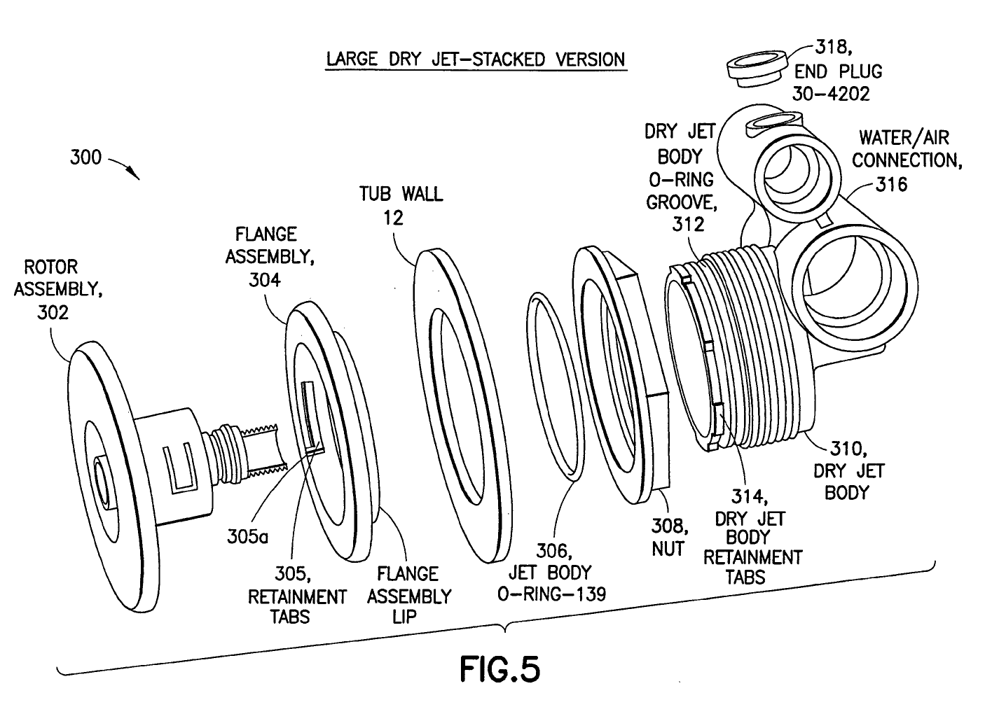

In particular, FIGS. 4a, 4b, 4c are cross-sectional assembled views of embodiments, generally indicated by reference numerals 100 (FIG. 4a), 200 (FIG. 4b), 300 (FIG. 4c), of the basic dry jet invention shown in relation to three different water and air connections generally indicated as 316, 316′, 316″ that form part of the overall dry jet body, but do not form part of the overall invention. In other words, the scope of the invention is not intended to be limited to any type or kind of water and air connections that form part of the dry jet body. The features of the embodiments shown in FIGS. 4a, 4b, 4c are labelled consistent with that shown and described herein in relation to FIGS. 5-10b.

FIG. 5 shows an exploded view of the dry jet 300 shown in FIG. 4c, which includes a rotary assembly 302, a flange assembly 304, a jet body O-ring 306, a nut 308 and a dry jet body 310 with an O-Ring groove 312, jet body retainment tabs 314, dry water/air connections 316 and an end plug 318. The dry jet 300 is arranged in relation to a bathtub or spa wall 12, which is shown in part. The flange assembly 304 includes four retainment tabs 305 that rotationally cooperate with the corresponding retainment tabs 314 of the jet body 310 to hold or secure the flange assembly 304 to the jet body 310 and against the tub or spa wall 12 when fully assembled, as shown in FIG. 4c. The retainment tab 305 has a retainment tab stop 305a for stopping the rotational movement. Although the flange assembly 304 and jet body 310 are shown with four retainment tabs 305, 314, the scope of the invention is not intended to be limited to any particular number of retainment tabs, consistent with that described above. For example, embodiments are envisioned in which the flange assembly 304 and jet body 314 each have two respective retainment tabs, three respective retainment tabs, five respective retainment tabs, etc.

The dry jet 300 is assembled as follows:

1) The threaded nut 308 is placed on the jet body 310.

2) The jet body 310 is inserted into the tub wall 12 far enough so that the jet body O-ring 306 may be arranged in the O-ring channel 312 of the jet body 310.

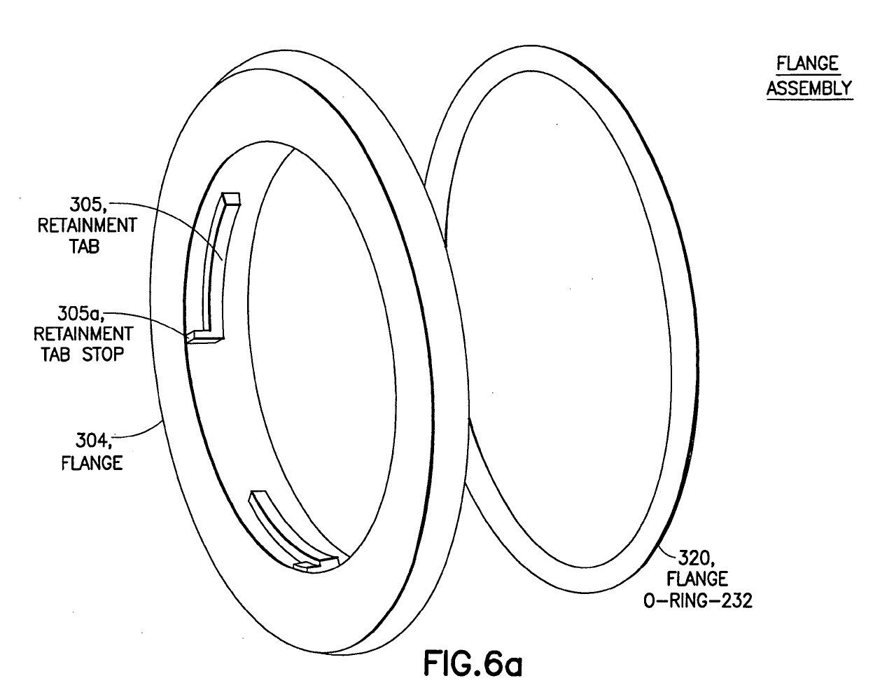

3) The flange O-ring (see FIGS. 6a, 6b) is inserted in the flange O-ring groove or channel 319 and the flange assembly 304 is arranged on the jet body 310 so that the retainment tabs 305 of the flange assembly 304 rotationally cooperate with corresponding retainment tabs 314 of the jet body 310 to hold or secure the flange assembly 304 on the jet body 310.

4) The threaded nut 308 is tightened until the jet body O-ring 306 becomes wedged between the lip 321 (FIG. 6b) of the flange assembly 304 and the jet body 310, and until the flange assembly O-ring 320 (FIGS. 6a, 6b) is pressed against the tub wall 12, so as to provide a watertight seal between the flange assembly 304 and the tub wall 12, as well as the flange assembly 304 and the jet body 310.

5) The rotor assembly 302 is snapped over and onto the flange assembly 304 so as to allow rotational movement.

In effect, this embodiment provides for the use of an O-ring to retain a flange that can be placed on the end of a plastic plumbing fitting to allow it to be secured to a bathtub or spa wall. An O-ring groove may be made in the plastic fitting. A threaded nut is placed on the fitting and it is inserted through the wall.

In operation, the flange with a tapered cylindrical shape is placed over the fitting far enough past the O-ring groove so that the O-ring can be installed. The O-ring is then installed, and when the threaded nut on the fitting is tightened, the flange becomes wedged between the o-ring and fitting forming a good mechanical and watertight seal.

In another embodiment, the flange is secured to the dry jet body by retainment tabs of the flange which rotationally cooperate with corresponding retainment tabs of the dry jet body.

FIGS. 6a and 6b show front and rear views of the flange assembly and flange assembly O-ring.

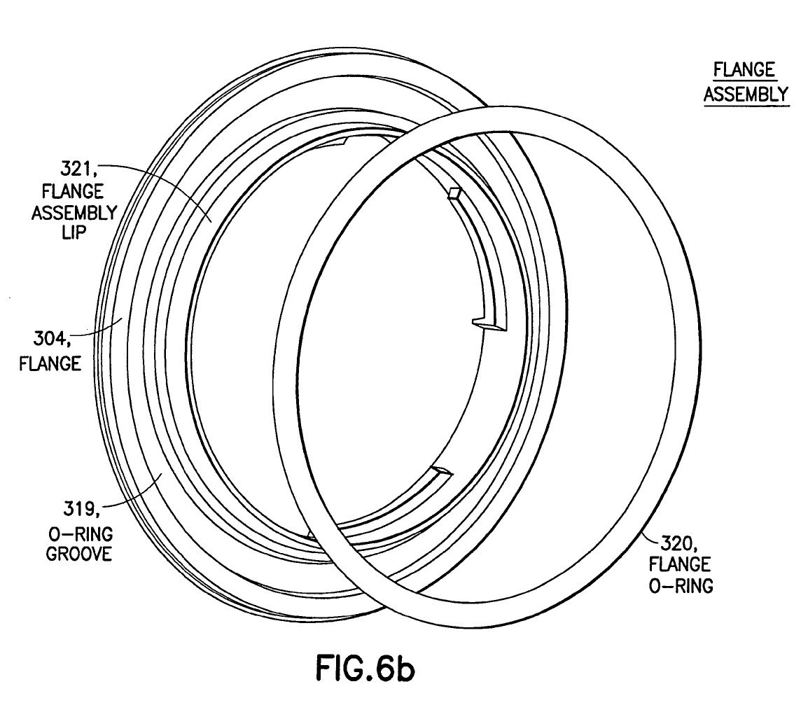

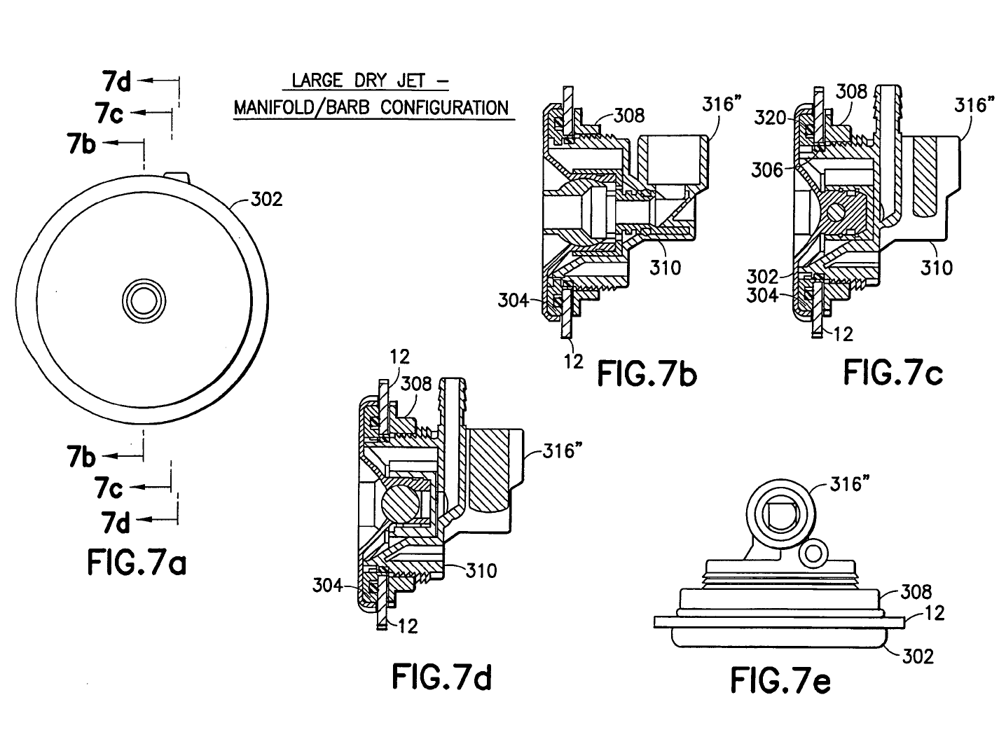

FIGS. 7a, b, c, d and e show the manifold/barb configuration of the dry jet 100 shown in FIG. 4a, having the water/air connections 316″. Similar elements in FIGS. 7a, b, c, d and e and FIG. 5 are labelled with similar reference numerals.

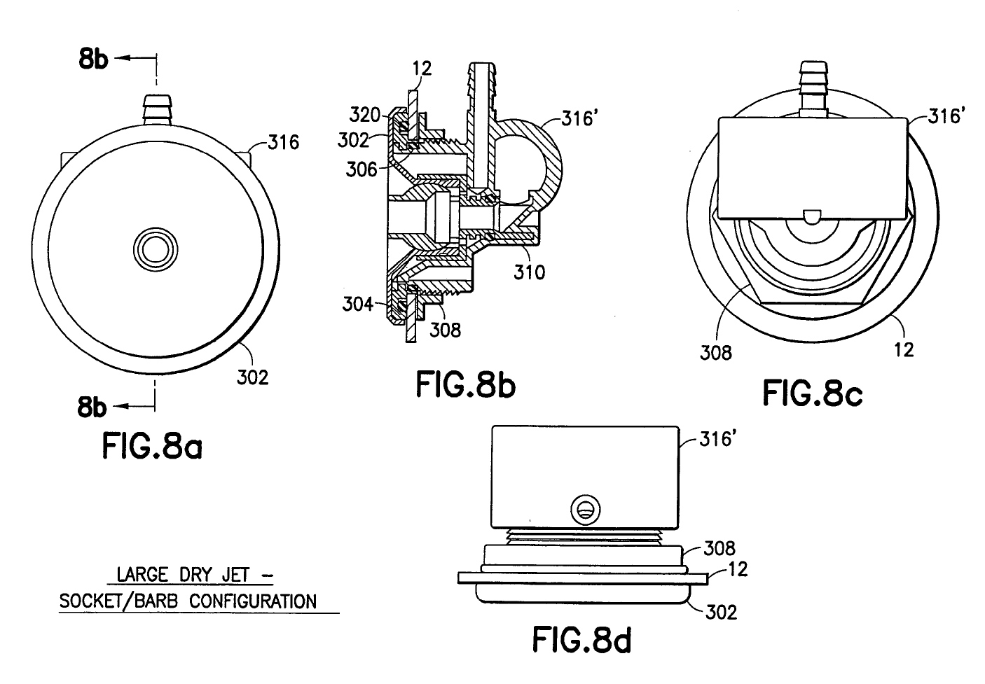

FIGS. 8a, b, c and d show the socket/barb configuration of the dry jet 200 shown in FIG. 4b, having the water/air connections 316′. Similar elements in FIGS. 8a, b, c and d and FIG. 5 are labelled with similar reference numerals.

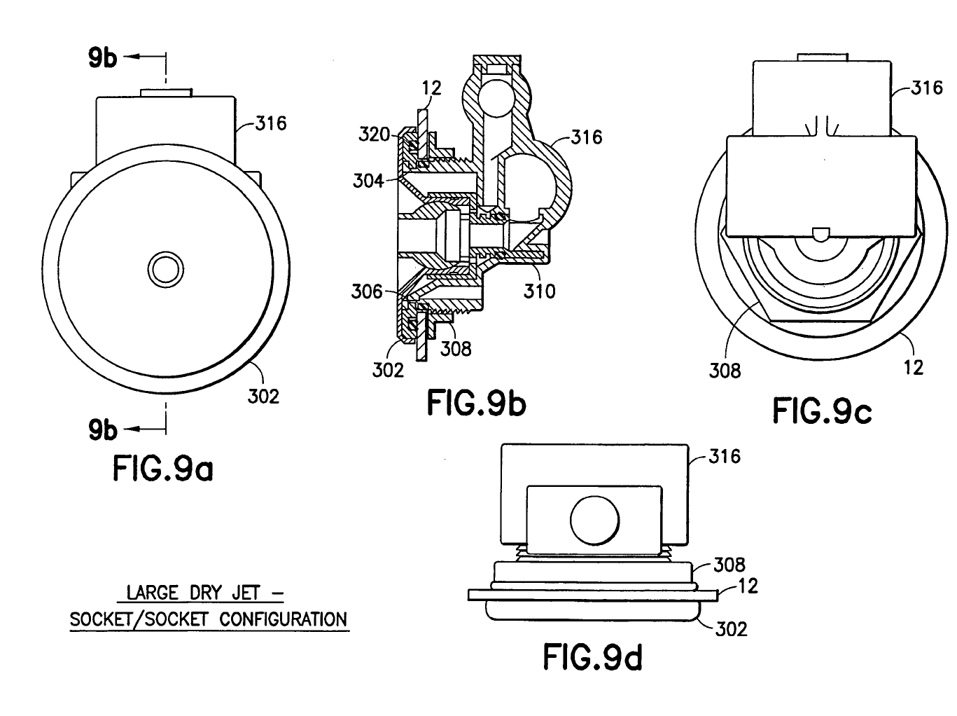

FIGS. 9a, b, c and d show the socket/socket configuration of the dry jet 300 shown in FIG. 4c, having the water/air connections 316. Similar elements in FIGS. 9a, b, c and d and FIG. 5 are labelled with similar reference numerals.

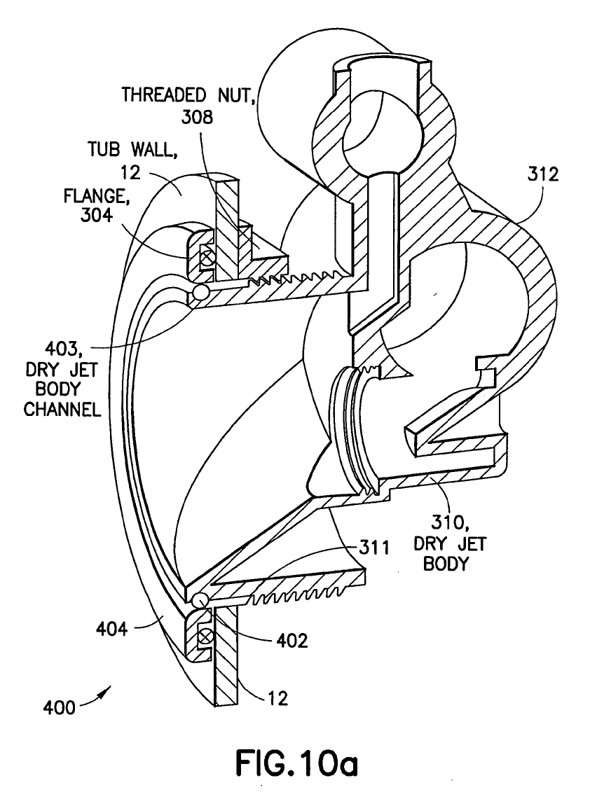

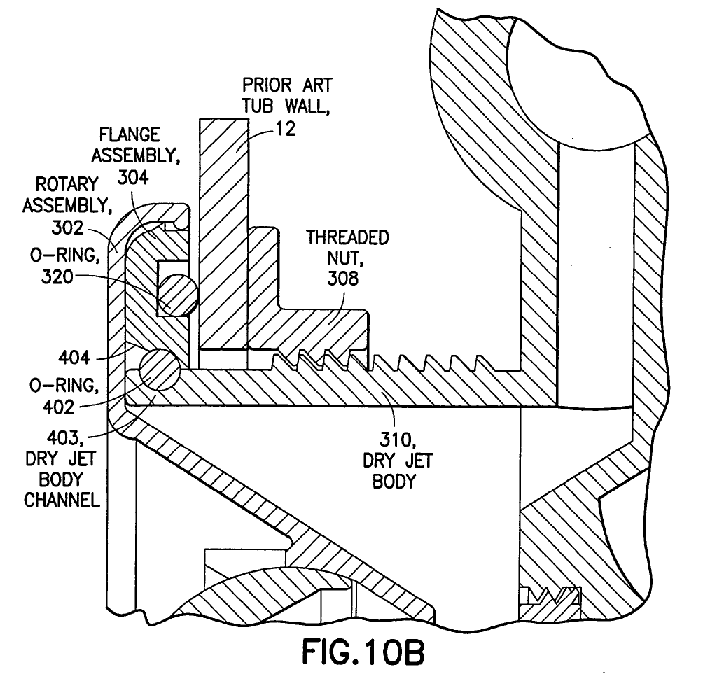

FIGS. 10a, 10b show cross-sectional views of an alternative embodiment generally indicated as 400 of the present invention. Similar elements in FIGS. 10a and 10b and FIG. 5 are labelled with similar reference numerals. In this embodiment, the jet body O-ring 402 is arranged in an O-ring groove or channel 403 and becomes wedged between an angled surface or channel 404 of the flange 304 and the jet body fitting 311 when the threaded nut 308 on the jet body fitting 311 is tightened. In FIGS. 10a and b, the O-ring 402 is shown squeezed and retained in place between the flange 304 and the O-ring channel 304 of the dry jet body 310.

The dry jet 400 is assembled as follows:

1) The threaded nut 308 is placed on the jet body 310.

2) The jet body 310 is inserted into the tub wall 12 far enough so that the jet body O-ring 402 may be arranged in the O-ring channel 403 of the jet body 310.

3) The flange O-ring 320 is inserted in the flange O-ring channel 319 (FIG. 66b) and the flange assembly 304 is arranged on the jet body 310.

4) The jet body O-ring 402 is arranged in the jet body O-ring channel 403.

5) The threaded nut 308 is tightened until the jet body O-ring 402 becomes wedged between the angled circumferential surface 404 of the flange assembly 304 and the jet body 310, and until the flange assembly O-ring 320 is pressed against the tub wall 12, so as to provide a watertight seal between the flange assembly 304 and the tub wall 12, as well as the flange assembly 304 and the jet body 310.

6) The rotor assembly 302 is snapped over and onto the flange assembly 304 so as to allow rotational movement.

### Comparison of Designs

The following is a comparison of the designs in FIGS. 1-3 versus that in FIGS. 4-10b:

The following are changes to the designs in FIGS. 1-3 versus that in FIGS. 4-10b:

a) The flange is attached to the wall with the nut first, and

b) Then the jet body is inserted into the flange from behind the tub wall and rotated ⅛ turn. The rotation of the jet body causes it to advance into the flange. After rotation, the jet body becomes locked to the flange and will not separate.

The following is a brief description of the differences between the two designs according to the present invention:

In the design in FIGS. 4-10b, it was difficult for the installer to push the flange over the jet body due to the force required to seat the O-Ring. The design in FIGS. 1-3 uses the mechanical advantage obtained by twisting the jet body to advance the jet body into the flange.

Moreover, in the design in FIGS. 4-10b, it was possible for the flange to become unattached to the jet body if the nut was loosened after installation. The design in FIGS. 1-3 solves this problem by using locking tabs to snap the jet body into position after rotation. This prevents the flange from becoming detached after installation.

### Incorporation of Earlier-Filed Provisional Application

The application relates to provisional patent application No. 60/619,075, filed 15 Oct. 2004, which is hereby incorporated by reference in its entirety.

### Scope of the Invention

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

1. A method for coupling a fitting arrangement to a tub or spa wall, comprising:
inserting a wall fitting having one or more corresponding rotational locking members through a mounting opening in the tub or spa wall; and
snapping one or more corresponding rotational locking members on a jet body onto one or more rotational locking members on the wall fitting as the jet body is advanced into the wall fitting to prevent the jet body and wall fitting from separating from one another.

2. A method according to claim 1, wherein the one or more corresponding rotational locking members on the jet body include one or more locking tabs.

3. A method according to claim 2, wherein the one or more locking tabs are arranged on an outer circumferential surface of the jet body.

4. A method according to claim 1, wherein the one or more rotational locking members on the wall fitting include one or more indent tabs.

5. A method according to claim 4, wherein the one or more indent tabs are arranged on an inner circumferential surface of the wall fitting.

6. A method according to claim 1, wherein the step of snapping comprises:
coupling one or more advancing tabs on the jet body and one or more corresponding advancing tabs on the wall fitting; and
rotating the jet body in relation to the wall fitting to advance the jet body into the wall fitting.

7. A method according to claim 6, wherein the one or more advancing tabs have an angled surface in relation to the cylindrical axis of the jet body.

8. A method according to claim 6, wherein the one or more advancing tabs are arranged on an outer circumferential surface of the jet body.

9. A method according to claim 6, wherein the one or more corresponding advancing tabs have an angled surface in relation to the cylindrical axis of the wall fitting.

10. A method according to claim 6, wherein the one or more corresponding advancing tabs are arranged on an inner circumferential surface of the wall fitting.

11. A method according to claim 6, wherein the one or more rotational locking members are locking tabs that are formed separately from the one or more advancing tabs, or that are formed as part of the one or more advancing tabs, or some combination thereof.

12. A method according to claim 6, wherein the one or more corresponding rotational locking members are indent tabs that are formed separately from the one or more corresponding advancing tabs, or that are formed as part of the one or more corresponding advancing tabs, or some combination thereof.

13. A method according to claim 1, wherein the step of inserting further comprises:
threading a nut onto the wall fitting to hold the wall fitting in place.

14. A method according to claim 1, wherein the step of inserting further comprises:
arranging an O-ring between the tub or spa wall and the wall fitting to provide a water tight seal.

15. A method according to claim 1, wherein the step of snapping comprises:
arranging an O-ring between the tub or spa wall and the jet body to provide a water tight seal.

16. A fitting arrangement for coupling to a tub or spa wall, comprising:
a wall fitting having one or more rotational locking members for inserting through a mounting opening in the tub or spa wall; and
a jet body having one or more corresponding rotational locking members for snapping onto the one or more rotational locking members of the wall fitting as the jet body is advanced into the wall fitting to prevent the jet body and wall fitting from separating from one another.

17. A fitting arrangement according to claim 16, wherein the one or more corresponding rotational locking members on the jet body include one or more locking tabs.

18. A fitting arrangement according to claim 17, wherein the one or more locking tabs are arranged on an outer circumferential surface of the jet body.

19. A fitting arrangement according to claim 16, wherein the one or more rotational locking members on the wall fitting include one or more indent tabs.

20. A fitting arrangement according to claim 19, wherein the one or more indent tabs are arranged on an inner circumferential surface of the wall fitting.

21. A fitting arrangement according to claim 16, wherein the jet body includes one or more advancing tabs that rotationally cooperate with one or more corresponding advancing tabs of the wall fitting to advance the jet body into the wall fitting.

22. A fitting arrangement according to claim 21, wherein the one or more advancing tabs have an angled surface in relation to the cylindrical axis of the jet body.

23. A fitting arrangement according to claim 21, wherein the one or more advancing tabs are arranged on an outer circumferential surface of the jet body.

24. A fitting arrangement according to claim 21, wherein the one or more advancing tabs have an angled surface in relation to the cylindrical axis of the wall fitting.

25. A fitting arrangement according to claim 21, wherein the one or more advancing tabs are arranged on an inner circumferential surface of the wall fitting.

26. A fitting arrangement according to claim 21, wherein the one or more rotational locking members are locking tabs that are formed separately from the one or more advancing tabs, or that are formed as part of the one or more advancing tabs, or some combination thereof.

27. A fitting arrangement according to claim 21, wherein the one or more corresponding rotational locking members are indent tabs that are formed separately from the one or more corresponding advancing tabs, or that are formed as part of the one or more corresponding advancing tabs, or some combination thereof.

28. A fitting arrangement according to claim 16, wherein the fitting arrangement further comprises:
a nut threaded onto the wall fitting to hold the wall fitting in place.

29. A fitting arrangement according to claim 16, wherein the fitting arrangement further comprises:
an O-ring arranged between the tub or spa wall and the wall fitting to provide a water tight seal.

30. A fitting arrangement according to claim 16, wherein the fitting arrangement further comprises:
an O-ring arranged between the tub or spa wall and the jet body to provide a water tight seal.

31. A fitting arrangement for coupling a dry jet body of a dry jet to a tub or spa wall of a bath tub or spa using a flange, comprising:
a flange having a flange sealing member arranged between respective surfaces of the flange and the tub or spa wall for providing a substantially water tight seal and has one or more flange retainment tabs; and
a jet body having a dry jet body sealing member arranged between corresponding surfaces of the flange and the jet body and has one or more jet body retainment tabs,
so that when the flange is coupled to the jet body and rotated thereon the one or more flange retainment tabs cooperate with the one or more jet body retainment tabs so as to frictionally engage and retain the flange in relation to the jet body for providing a substantially water-tight seal between the jet body and the tub or spa wall.

32. A fitting arrangement according to claim 31, wherein the fitting arrangement further comprises an O-ring arranged between an angled surface of the wall fitting and a circumferential channel of the jet body for providing an improved water tight seal.
